(19) United States
(12) Patent Application Publication
(10) Pub. No.: US 2017/0091613 A1
(43) Pub. Date: Mar. 30, 2017

(54) COMPUTATIONAL DEVICE, COMPUTATIONAL METHOD, AND COMPUTER PROGRAM PRODUCT

(71) Applicant: Kabushiki Kaisha Toshiba, Tokyo (JP)

(72) Inventors: Satoshi ITO, Kawasaki Kanagawa (JP); Tomoki WATANABE, Inagi Tokyo (JP)

(21) Appl. No.: 15/260,210

(22) Filed: Sep. 8, 2016

(30) Foreign Application Priority Data
Sep. 30, 2015 (JP) 2015-193630

(51) Int. Cl. G06N 3/02; G06N 5/04

(52) U.S. Cl. CPC G06N 3/02; G06N 5/04

(57) ABSTRACT

According to an embodiment, a computational device includes a memory and a processor. The processor receives an input of tensor data. The processor locates a first area on the tensor data. The processor maps the coordinates within the first area on the tensor data and to acquire a second area including corresponding coordinates which the coordinates within the first area on the tensor data are mapped to. The processor calculates a higher-order statistic between the first area and the second area. The processor outputs the higher-order statistic.

### CROSS-REFERENCE TO RELATED APPLICATIONS

This application is based upon and claims the benefit of priority from Japanese Patent Application No. 2015-193630, filed on Sep. 30, 2015; the entire contents of which are incorporated herein by reference.

### FIELD

Embodiments described herein relate generally to a computational device, a computational method, and a computer program product.

### BACKGROUND

Recently, a mathematical model referred to as a neural network has found its applications in the field of pattern recognitions such as image recognition and speech recognition. The neural network includes a plurality of computational layers, and these computational layers perform iterative computations in response to an input of a pattern that is a recognition target, and outputs the result of the pattern recognition such as detection, identification, and labelling.

Computational layers referred to as a convolution layer and a fully connected layer are mainly used as the computational layers included in a neural network. The computation performed in a convolution layer is represented by Equation (1), for example.

$$y ( r ) = f ( b + {\sum }_{d ∈ D} w ( d ) x ( r + d ) ) \qquad ( 1 )$$

Here, x denotes tensor data input to the convolution layer; x(r+d) denotes the value at the coordinate (r+d) in the tensor data; w(d) denotes the weight at a coordinate d of a filter applied to the tensor data; D denotes a set of coordinates within the range defined by the filter; and b denotes a constant bias. f( ) denotes a non-linear function, and generally a sigmoid function, a tank function, or a rectified linear unit (ReLU) function is used as the non-linear function. y denotes the tensor data output from the convolution layer, and y(r) denotes the output value at a coordinate (r) in the tensor data. The tensor data is expressed as a multi-dimensional array.

When the range D defined by the filter is exactly the same as the coordinate range of the input tensor data x, in other words, when all of the elements in the tensor data fit exactly within the filter window, Equation (1) represents the computation performed in the fully connected layer.

As may be clear from Equation (1), the computation performed in the convolution layer or the fully connected layer is to apply nonlinear processing to the linear combination of the element values of the input tensor data x, and this computational is enabled to present first-order statistics related to the input tensor data x.

### BRIEF DESCRIPTION OF THE DRAWINGS

FIG. 1 is a flowchart illustrating an exemplary process performed in a neural network;

FIG. 2 is a schematic for explaining an example of a function fᵢ( );

FIG. 3 is a schematic illustrating a configuration of a computational device according to an embodiment;

FIG. 4 is a flowchart illustrating an exemplary process according to the embodiment;

FIG. 5 is a schematic illustrating an example of a vehicle according to an application example;

FIG. 6 is a schematic illustrating an exemplary configuration of the vehicle according to the application example;

FIG. 7 is a schematic illustrating an example of a configuration of a recognizing unit according to the application example in detail;

FIG. 8 is a schematic illustrating an example of an input image according to the application example; and

FIG. 9 is a schematic illustrating an example of an output image according to the application example.

### DETAILED DESCRIPTION

According to an embodiment, a computational device includes a memory and a processor. The processor receives an input of tensor data. The processor locates a first area on the tensor data. The processor maps the coordinates within the first area on the tensor data and to acquire a second area including corresponding coordinates which the coordinates within the first area on the tensor data are mapped to. The processor calculates a higher-order statistic between the first area and the second area. The processor outputs the higher-order statistic.

An embodiment will now be explained in detail with reference to the accompanying drawings.

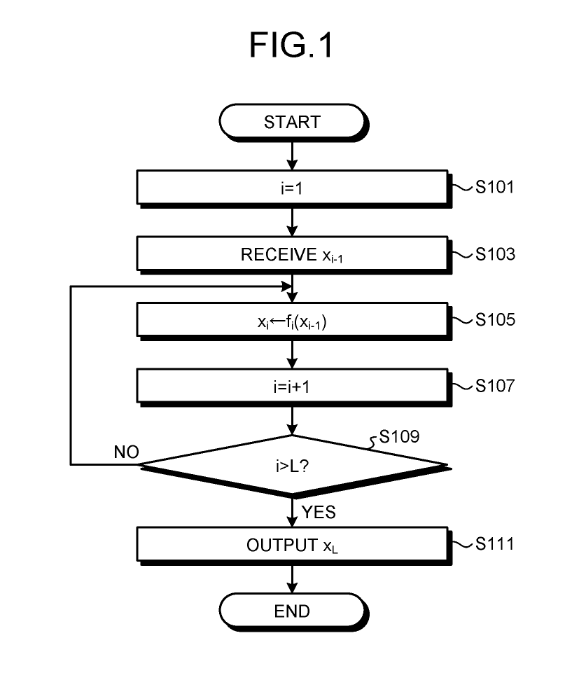

To begin with, the sequence of computations performed in a neural network will be explained briefly. FIG. 1 is a flowchart illustrating an example of the sequence of steps included in a process performed in a neural network. In the example illustrated in FIG. 1, the neural network includes L computational layers (where L is a natural number equal to or greater than two).

To begin with, a variable i is initialized to one (Step S101).

An i-th computational layer in the neural network receives an input of tensor data xᵢ₋₁ (Step S103).

Examples of the tensor data x₀ input to the neural network include existing feature vectors such as speech feature values or image feature values, still image data, multi-spectrum image data, video data, distance image data, three-dimensional shape data, ultrasonic image data, magnetic resonance imaging (MRI) image data, three-dimensional computed tomography (CT) image data, and these types of data arranged in the chronological order. However, the tensor data is not limited to these examples, and may be any tensor data. The tensor data can be expressed as a multi-dimensional array, as mentioned earlier.

The i-th computational layer then converts the tensor data xᵢ₋₁ into tensor data xᵢ using a function fᵢ( ) (Step S105).

The variable i is then incremented (Step S107). If the resultant value of the variable i is equal to or less than L (No at Step S109), the process at Steps S105 to S107 is iterated.

If the resultant value of the variable i is greater than L (Yes at Step S109), the L-th computational layer of the neural network outputs tensor data x. (Step S111).

The tensor data x_{L} output from the neural network is dependent on the type of pattern recognition to which the neural network is applied.

For example, when the neural network is applied to an classification problem, e.g., inferring the category to which the tensor data x₀ input to the neural network belongs, the tensor data x_{L} may represent the scores of the respective categories.

As another example, when the neural network is applied to a regression problem, e.g., estimating the age of a person based on an image of his/her face included in the tensor data x₀ input to the neural network, the tensor data x_{L} may be the objective variable of the regression (estimated age, in the example of age estimation).

As another example, when the neural network is applied to a labelling problem, e.g., inferring the category to which each one of the elements in the tensor data x₀ input to the neural network belongs, such as that in image scene labelling, the tensor data x_{L} may present the scores of the respective categories for the corresponding element.

These exemplary neural network applications are merely examples, and the application of the neural network is not limited to these examples.

When the neural network receives an input of tensor data x₀, each of the L computational layers converts the data one after another, and the final tensor data x_{L} is output. The data (x₁, . . . , x_{L-1}) between the tensor data x₀ and the tensor data x_{L} are also represented as tensors.

The conversion from tensor data x₀ to the tensor data x_{L} is expressed as Equation (2) below.

x_{L}=f_{L}(f_{L-1}( . . . f₂(f₁(x₀)) . . . )) (2)

The function fᵢ( ) represents the conversion at the i-th computational layer, as mentioned earlier. Well-known examples of this conversion include convolution, pooling, and local contrast normalization.

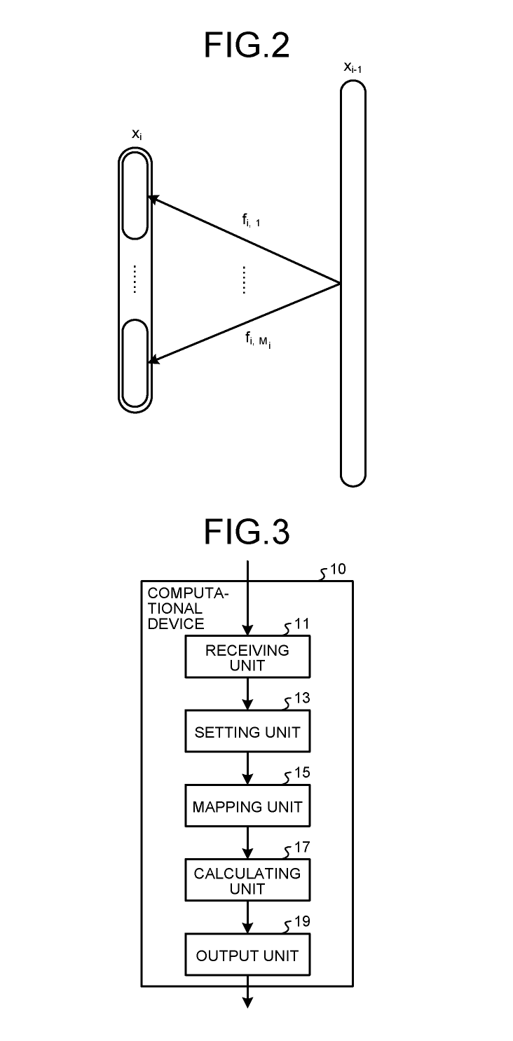

As illustrated in FIG. 2, the function fᵢ( ) may include Mᵢ different functions f_{(i, 1)}, . . . , f_{(i, Mi)} (where Mᵢ is a natural number equal to or greater than two). In other words, the function fᵢ( ) may be a parallel combination of different types of computations, without limitation to one type of computation. For example, convolution and pooling may be combined in parallel. The function fᵢ( ) may be a parallel combination of convolutions with different kernel sizes, as disclosed in C. Szegedy et. al, “Going Deeper with Convolutions”, CVPR2015.

In this manner, in a neural network, intended output data is generated by applying a plurality of conversions to input data one after another. When there is any higher-order relation within the tensor data xᵢ, and a plurality of conversions are used to express a higher-order relation, the number of computational layers included in the neural network becomes increased, and, therefore, the size of the network is also increased.

To address this issue, used in the embodiment is a conversion for expressing the higher-order relation in the tensor data within one computational layer. This conversion may be used as the function fᵢ( ) or the function f_{(i, j)} described above.

FIG. 3 is a schematic illustrating a configuration of an example of a computational device 10 according to the embodiment. As illustrated in FIG. 3, the computational device 10 includes a receiving unit 11, a setting unit 13, a mapping unit 15, a calculating unit 17, and an output unit 19.

The receiving unit 11, the setting unit 13, the mapping unit 15, the calculating unit 17, and the output unit 19 may be implemented as hardware such as an integrated circuit (IC), implemented by causing a processor such as a central processing unit (CPU) to execute a computer program, that is, implemented as software, or may be implemented as a combination of software and hardware.

The computational device 10 according to the embodiment performs the computation executed in a computational layer (such as a convolution layer or a fully connected layer) making up a neural network.

The receiving unit 11 receives an input of tensor data. This tensor data corresponds to the tensor data xᵢ₋₁ described above. The tensor data received by the receiving unit 11 may be part of the tensor data xᵢ₋₁ described above instead of the entire tensor data Furthermore, it is assumed in the embodiment that the element values in the tensor data (the values at the respective coordinates, e.g., pixel values) are continuous values. The element values (such as pixel values) in the tensor data may be normalized to the range of [0, 1]. Furthermore, although it is assumed herein in the embodiment that the rank of the tensor data is three, but the rank may be one, two, four, or higher, without limitation to three.

If the computation performed by the computational device 10 corresponds to the computational in the first layer, among the computational layers included in the neural network, the receiving unit 11 receives an input of the tensor data x₀ (for example, image data) as the tensor data. If the computation performed by the computational device 10 corresponds to the computational in the n-th layer (where n is a natural number equal to or greater than two), among the computational layers included in the neural network, the receiving unit 11 receives an input of tensor data xₙ₋₁ (for example, feature map) output from the (n−1)-th computational layer, as the tensor data.

The setting unit 13 sets a first area D to the tensor data received by the receiving unit 11. The coordinates included in the first area D do not necessarily need to be continuous within the tensor data.

The mapping unit 15 maps the coordinates included in the first area D set by the setting unit 13 to those in the tensor data received by the receiving unit 11, and acquires a second area E including the coordinates after the mapping. The mapping performed by the mapping unit 15 is expressed as Equation (3).

E={r₂|r₂=g(r₁)̂r₁∈D} (3)

The first area D or a map g is set in such a manner that the entire coordinates included in the second area E are found in the tensor data. Any map may be used as long as it is a map g satisfying this condition. For example, the map g may be a random map, a linear map, an affine transformation, a translation, or may also be a map in which destination coordinates for mapping the coordinates are designated by a user in advance.

The calculating unit 17 calculates higher-order statistics s between the first area D set by the setting unit 13 and the second area E acquired by the mapping unit 15. Explained in the embodiment is an example in which the order of the higher-order statistics s is two, but the order is not limited thereto. Furthermore, explained in the embodiment is an example in which the higher-order statistics s are the accumulation of the product of the value at each of the coordinates in the first area D and the value at the corresponding coordinate after mapping in the second area E that is a map of the coordinates in the first area D, but the embodiment is not limited thereto. The calculating unit 17 calculates the higher-order statistics s using Equation (4) or Equation (5), for example. The value of the higher-order statistics s corresponds to the value at the right hand side of Equation (1).

$$s = {\sum }_{r ∈ D} h ( x ( r ) , x ( g ( r ) ) ) \qquad ( 4 )$$

Where h(x(r), x(g(r))) is a function representing a higher-order polynomial of x(r) and x(g(r)). x(r) is the value (such as the pixel value) at the coordinate r in the first area D. x(g(r)) is the value at a coordinate g(r) which is a map of the coordinate r in the second area E (e.g., pixel value).

$$s = {\vert D \vert}^{- 1} {\sum }_{r ∈ D} h ( x ( r ) , x ( g ( r ) ) ) \qquad ( 5 )$$

Where |D| denotes the number of elements in the set D.

A higher-order polynomial such as those provided in Equations (6) to (8) may be used as h(x(r), x(g(r))) specified in Equations (4) and (5), for example. The higher-order polynomial is not, however, limited to these examples, and any higher-order polynomial may be used.

h(x,y)=xy (6)

h(x, y)=(x−y)² (7)

h(x, y)=(x+y−xy)(1−xy) (8)

The output unit 19 outputs the higher-order statistics s calculated by the calculating unit 17.

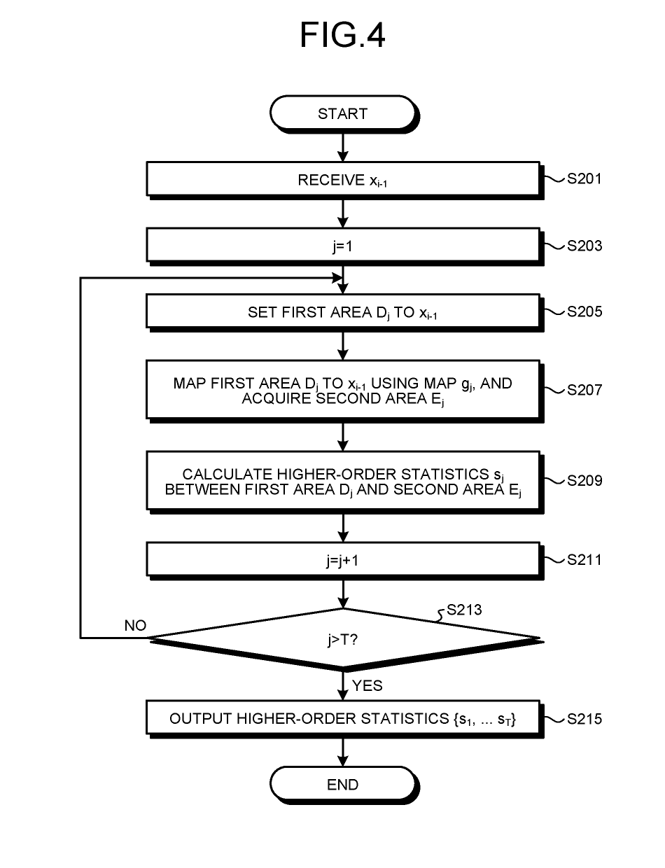

FIG. 4 is a flowchart illustrating an example of the sequence of steps included in a process according to the embodiment.

To begin with, the receiving unit 11 receives an input of the tensor data xᵢ₋₁ (Step S201).

The calculating unit 17 then initializes the value of a variable j to one (Step S203).

The setting unit 13 then sets the first area Dⱼ to the tensor data xᵢ₋₁ (Step S205).

The mapping unit 15 then maps the first area Dⱼ to the tensor data xᵢ₋₁ using a map gⱼ, and acquires a second area Eⱼ (Step S207).

The calculating unit 17 then calculates higher-order statistics sⱼ between the first area Dⱼ and the second area Eⱼ (Step S209).

The calculating unit 17 then increments the value of the variable j (Step S211). If the resultant value of the variable j is equal to or less than T (No at Step S213), the process at Steps S205 to S211 is iterated.

If the resultant value of the variable j is greater than T (Yes at Step S213), the output unit 19 outputs the higher-order statistics {s₁, . . . , s_{T}} as the tensor data xᵢ (Step S215).

As described above, according to the embodiment, because a higher-order relation in tensor data is calculated, a higher-order relation within tensor data can be captured. In particular, in the embodiment, a conversion for expressing a higher-order relation within the tensor data in one layer is introduced. Therefore, the embodiment enables the number of computational layers included in the neural network to be reduced, so that the network size can be reduced as well, and the power consumption and the onboard memory capacity can be suppressed, and, as a result, costs can be reduced. In other words, according to the embodiment, a higher-order relation within tensor data can be captured while enabling costs reduction.

First Modification

Used in the embodiment described above is an assumption that the element values in the tensor data are continuous values. Used in a first modification of the embodiment, however, is an assumption that the element values in the tensor data are binary. In the description below, the difference with respect to the embodiment will be mainly explained, and the elements having the same functions as those according to the embodiment will be given the same names and reference numerals, and explanations thereof are omitted.

In the first modification, the values of the elements (the values at the respective coordinates such as pixel values) in the tensor data received by the receiving unit 11 are binary. Explained herein in the first modification is an example in which the element values in the tensor data is binary taking either {0, 1}, but the value taken as a binary is not limited to {0, 1}.

In the first modification, the calculating unit 17 calculates higher-order statistics s between the first area D and the second area E using Equation (9), for example.

$$s = {\sum }_{r ∈ D} {H}_{x ( r ) , x ( g ( r ) )} \qquad ( 9 )$$

Where H_{x,y} is expressed as Equation (10).

H_{x,y}=h(x, y) for x, y∈{0,1} (10)

In this manner, when the element values in the tensor data are binary, because the function h(x, y) takes only four values of h(0, 0), h(1, 0), h(0, 1), and h(1, 1), these values can be calculated in advance. Therefore, in the first modification, the computational of the function h(x, y) does not need to be performed in real-time, so that the amount of computations can be reduced, and the power consumption can be reduced as well.

Application Example

Explained in this application example is an application example of the computational device 10 explained in the embodiment and the first modification. The computational device 10 explained in the embodiment and the first modification can reduce the size of the neural network, and reduce the amount of computations performed in the computational layers included in the neural network, as mentioned earlier.

Therefore, by implementing the large-scale integration (LSI) performing computations for a neural network using the computational device 10, it is possible to implement an LSI performing computations for a neural network with a smaller-scaled circuit compared with a conventional counterpart. Such an LSI is suitable for embedded devices such as devices onboard vehicles and home appliances. In such embedded devices, a reduction in the circuit scale is rendered as an advantage in consideration of restricting factors such as the battery capacity, the selling price, and the amount of heat generation in embedded devices.

Explained below as an application example is an example in which an LSI using the computational device 10 is mounted onboard a vehicle, and the LSI is used to detect pedestrians via pattern recognition, but the application example is not limited thereto.

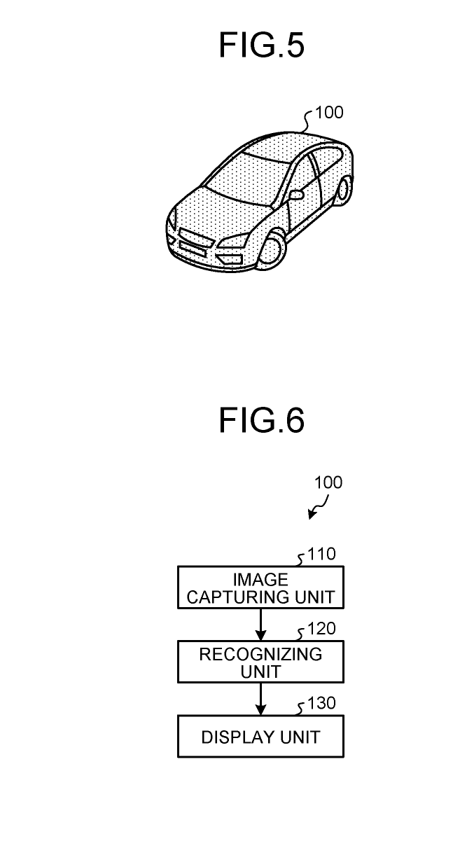

FIG. 5 is a schematic illustrating an example of a vehicle 100 according to this application example, and FIG. 6 is a schematic of an exemplary configuration of the vehicle 100 according to the application example. As illustrated in FIG. 6, the vehicle 100 includes an image capturing unit 110, a recognizing unit 120, and a display unit 130.

The image capturing unit 110 may be implemented using an image sensor such as a camera. The recognizing unit 120 may be implemented using an LSI. The display unit 130 may be implemented using a display, for example.

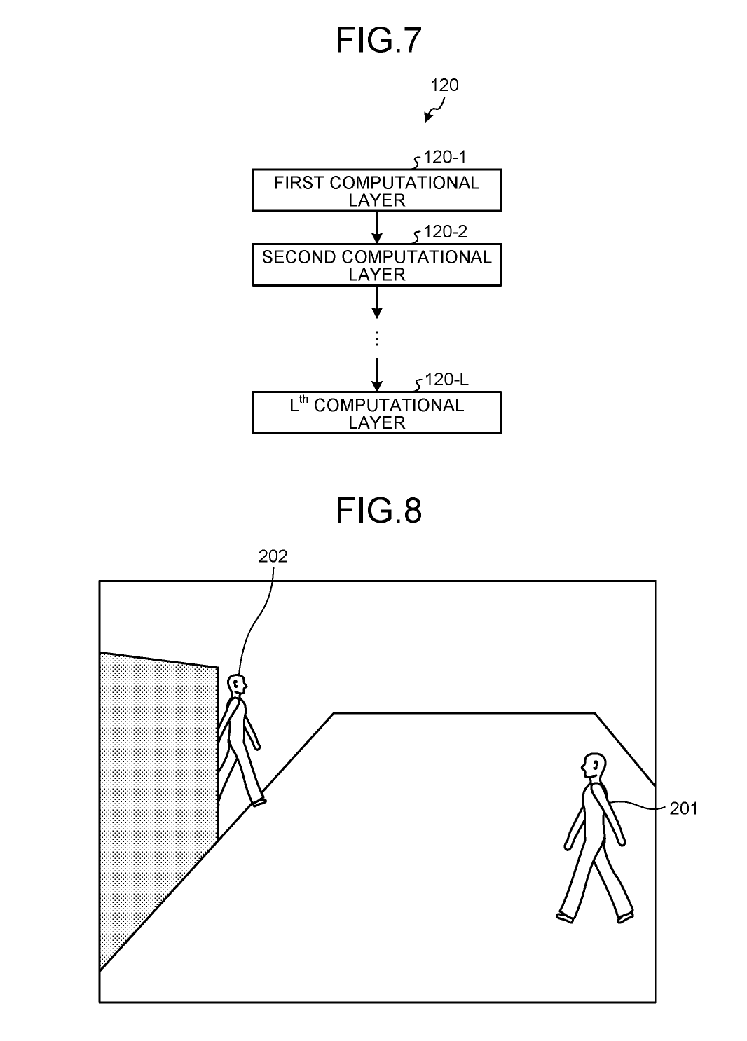

The recognizing unit 120 is an LSI performing computations for a neural network. FIG. 7 is a schematic illustrating an exemplary configuration of the recognizing unit 120 according to the application example in detail. As illustrated in FIG. 7, the recognizing unit 120 includes first to L-th computational layers 120-1 to 120-L. Among the first to the L-th computational layers 120-1 to 120-L, those required to capture a higher-order relation within tensor data have the configuration explained above for the computational device 10.

To the recognizing unit 120, an image captured by the image capturing unit 110 is input. For example, an image in which pedestrians 201 and 202 are captured as illustrated in FIG. 8 is input to the recognizing unit 120.

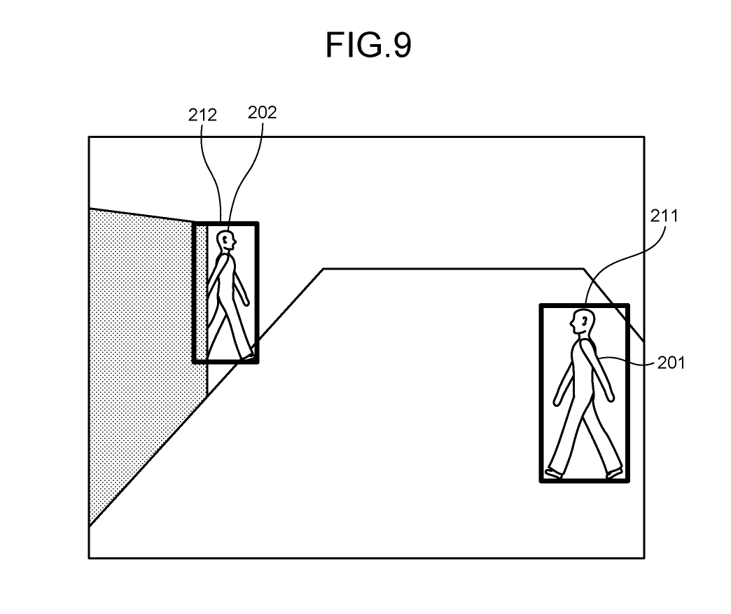

Upon receiving the input of the image (tensor data) from the image capturing unit 110, the first computational layer 120-1 in the recognizing unit 120 performs the computation for detecting pedestrians, and outputs a feature value map to the second computational layer 120-2. The second computational layer 120-2 then performs the computation for detecting pedestrians using the feature value map output from the first computational layer 120-1, and outputs its feature value map to the third computational layer 120-3. The L-th computational layer 120-L then finally outputs an image presenting the result of the pedestrian detection, and causes the display unit 130 to display the image. For example, the L-th computational layer 120-L outputs an image with frames 211 and 212 superimposed over the pedestrians 201 and 202, respectively, as illustrated in FIG. 9.

As described above, according to the application example, an LSI suitable for embedded devices performing computations for a neural network can be implemented.

The computational device 10 may implement a computational function for a neural network as software, instead of hardware (circuit). In such a case, with the computational function for a neural network, which is a software application of the computational device 10, system suitable for a server processing a large amount of data simultaneously, and those suitable for Internet services, for example can be implemented, and a system enabling cost reductions can be implemented because CPU utilization time or memory utilizations can be reduced.

Configuration of Computer Program

The computer program executed on the computational device 10 according to the embodiment and the modification, or the computer program executed in the application example is provided in a manner stored in a computer-readable storage medium such as a compact disc read-only memory (CD-ROM), a compact disc recordable (CD-R), a memory card, a digital versatile disc (DVD), and a flexible disk (FD), as a file in an installable or executable format.

Furthermore, the computer program executed on the computational device 10 according to the embodiment and the modification, or the computer program executed in the application example may be stored in a computer connected to a network such as the Internet, and made available for download over the network. Furthermore, the computer program executed on the computational device 10 according to the embodiment and the modification, or the computer program executed in the application example may be provided or distributed over a network such as the Internet. Furthermore, the computer program executed on the computational device 10 according to the embodiment and the modification, or the computer program executed in the application example may be provided incorporated in a ROM or the like in advance.

The computer program executed on the computational device 10 according to the embodiment and the modification, or the computer program executed in the application example has a modular structure for implementing the units described above on a computer. As actual hardware, these units are implemented on a computer by causing the CPU to read the computer program from the ROM or the HDD onto the RAM, and executing the computer program.

For example, the steps included in the flowchart according to the embodiment may be executed in a different order, executed simultaneously, or executed in a different order every time these steps are executed.

As described above, with the embodiment, the modification, and the application example, a higher-order relation within input tensor data can be captured.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A computational device comprising:
a memory; and
a processor coupled to the memory, wherein the processor is configured to:
receive an input of tensor data;
locate a first area on the tensor data;
map coordinates within the first area on the tensor data and to acquire a second area including corresponding coordinates which the coordinates within the first area on the tensor data are mapped to;
calculate a higher-order statistic between the first area and the second area; and
output the higher-order statistic.

2. The device according to claim 1, wherein the mapping comprises affine mapping.

3. The device according to claim 1, wherein the mapping comprises translating.

4. The device according to claim 1, wherein values of elements of the tensor data are continuous values.

5. The device according to claim 1, wherein values of elements of the tensor data are binary.

6. The device according to claim 1, wherein the higher-order statistic has an order of two.

7. The device according to claim 6, wherein the higher-order statistic is an accumulation of a product of a value at each of the coordinates in the first area and a value at the corresponding coordinate in the second area which the coordinates within the first area are mapped to.

8. The device according to claim 1, wherein the tensor data has a rank of three.

9. The device according to claim 1, wherein the tensor data is image data.

10. A computational method comprising:
by a hardware processor,
receiving an input of tensor data;
locating a first area on the tensor data;
mapping the coordinates within the first area on the tensor data, and acquiring a second area including corresponding coordinates which the coordinates within the first area on the tensor data are mapped to;
calculating a higher-order statistic between the first area and the second area; and
outputting the higher-order statistic.

11. The method according to claim 10, wherein the mapping comprises affine mapping.

12. The method according to claim 10, wherein the mapping comprises translating.

13. The method according to claim 10, wherein values of elements of the tensor data are continuous values.

14. The method according to claim 10, wherein values of elements of the tensor data are binary.

15. The method according to claim 10, wherein the higher-order statistic has an order of two.

16. The method according to claim 15, wherein the higher-order statistic is an accumulation of a product of a value at each of the coordinates in the first area and a value at the corresponding coordinate in the second area which the coordinates within the first area are mapped to.

17. The method according to claim 10, wherein the tensor data has a rank of three.

18. The method according to claim 10, wherein the tensor data is image data.

19. A computer program product comprising a non-transitory computer-readable medium including a computer program causing a computer to execute:
receiving an input of tensor data;
locating a first area on the tensor data;
mapping the coordinates within the first area on the tensor data, and acquiring a second area including corresponding coordinates which the coordinates within the first area on the tensor data are mapped to;
calculating a higher-order statistic between the first area and the second area; and
outputting the higher-order statistic.
